(19) United States
(12) Patent Application Publication
(10) Pub. No.: US 2022/0266390 A1
(43) Pub. Date: Aug. 25, 2022

(54) ULTRASONIC SENSOR BASED IN-SITU DIAGNOSTICS FOR AT LEAST ONE OF ADDITIVE MANUFACTURING AND 3D PRINTERS

(71) Applicant: UNIVERSITY OF NORTH TEXAS, Dallas, TX (US)

(72) Inventors: Arup NEOGI, Dallas, TX (US); Yuqi JIN, Dallas, TX (US); Teng YANG, Dallas, TX (US)

(21) Appl. No.: 17/677,592

(22) Filed: Feb. 22, 2022

Related U.S. Application Data
(60) Provisional application No. 63/153,240, filed on Feb. 24, 2021.

(51) Int. Cl. B23K 26/342; B22F 10/37; B22F 12/90; B33Y 50/02; B23K 26/03; B23K 26/0622; G01B 17/02; G01N 29/07

(52) U.S. Cl. CPC B23K 26/342; B22F 10/37; B22F 12/90; B33Y 50/02; B23K 26/03; B23K 26/0624; G01B 17/02; G01N 29/07; B22F 10/28

(57) ABSTRACT

A monitoring technique for a melting process including monitoring a melt pool produced by a heat source during the melting process, the monitoring comprising measuring ultrasonic time of flight of the melt pool via one or more ultrasonic transducers, wherein the melt pool comprises one or more metals, alloys, or a combination thereof. A system for carrying out the monitoring technique, and melting processes and systems utilizing the monitoring technique are also provided.

### CROSS-REFERENCES TO RELATED APPLICATIONS

This application claims the benefit of U.S. Provisional Application No. 63/153,240, filed on Feb. 24, 2021, and entitled “ULTRASONIC SENSOR BASED IN-SITU DIAGNOSTICS FOR ADDITIVE MANUFACTURING/3D PRINTERS,” which is incorporated herein by reference in its entirety for all purposes.

### STATEMENT REGARDING FEDERALLY SPONSORED RESEARCH OR DEVELOPMENT

This invention was made with government support under an Emerging Frontiers in Research and Innovation (EFRI) Grant No. 1741677 from the National Science Foundation (NSF). The government has certain rights in the invention.

### BACKGROUND

Materials processing can be carried out using various techniques. In some processes, molten materials can be used to form shapes and product through an additive manufacturing process. In this process, the materials are melted and placed in layers to build up and form a final shape. As the material cools, the final product can be formed. Upon formation of the product, post processing techniques can be used to finish the products for further use. Various types of defects can form in this process including malformed shapes as well as voids that can be difficult to detect during the formation process.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1A-1C are schematics depicting experimental setups: FIG. 1A depicts the experimental setup for measurement of the temperature dependent speed of sound; FIG. 1B depicts the experimental setup for in-situ gallium melting pool monitoring experiments; and FIG. 1C depicts the experimental setup for dynamic bulk modulus elastography mapping.

FIG. 2 is a graph depicting the temperature dependent of the speed of the longitudinal sound wave in gallium with various heating rates.

FIGS. 3A-3F are schematics of the in-situ melting pool monitoring of fast transition of laser-heated solid gallium sample having a sample thickness of about 1.9 millimeter (mm), using a 1.7 watt femtosecond laser focused into a 1 mm focusing spot on the upper surface of gallium sample; time of flight measurements are translated to distance of flight with the pre-tested speed of sound in gallium; FIGS. 3A-3E depict the heating process and FIGS. 3E to 3F depict the gallium sample after cooling and solidification after switching off the laser.

FIGS. 4A-4C are schematics of the in-situ melting pool monitoring of slower transition of a laser-heated solid gallium sample having a thickness of about 4.1 mm, using a 1.7 watts femtosecond laser focused into a 2 mm focusing spot on the upper surface of gallium sample; time of flight measurements translated to distance of flight with the pre-tested speed of sound in gallium; FIGS. 4A-4B depict the heating process; from FIGS. 4B-4C, the gallium sample is cooled and solidified back after switching off the laser.

FIG. 5 depicts ultrasound dynamic bulk modulus elastography imaging of the sample depicted in FIG. 3 after the laser induced melting; the color scale indicates the dynamic bulk modulus in the unit of gigapascal (GPa); the left subfigure illustrates that the location of the melting pool occurred and the ultrasound scanned area; and the offset of the laser induced melting pool is designed to demonstrate the capability of the elastography technique on an unequal heat dissipation resulting asymmetric heat affected soften region.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

This disclosure relates to in-situ (and ex-situ) evaluation of metal melt processes such as additive manufacturing processes, welding, joining, or the like. As an example, the evaluation can be used in laser aided selective area melting process of metals in additive manufacturing using ultrasonic diagnostics. More specifically, it relates to systems and methods of monitoring and enhancing manufacturing processes, such as welding and three-dimensional (3D) metal printing, via a monitoring technique for understanding metal and alloy melting and solidification.

The monitoring of the material processing during various metal working processes that involve melting of the metals (e.g., 3D printing or additive manufacturing) in real time is very challenging. The in-situ monitoring of material fabrication is very important for predicting the quality of the product developed during the manufacturing process. A sensitive sensor or sensing technique capable of predicting the material properties, such as mechanical strength or density of the material manufactured or any defect that is being formed during the printing process, will facilitate quality control. It will also provide a means to avoid wastage in the assembly line or stop the manufacturing during the printing process in case of any fault detection. In metal 3D printers, a laser or heat can be used to melt the metal.

When a laser is used, the laser can be a coherent single-phase beam of lights from a single wavelength with low beam divergence and high energy content. The laser can create heat when it strikes a metal surface. During laser-induced metal melt processes, such as laser welding and additive manufacturing, a moving melted volume, called the melt pool or melting pool, can be created. The size of this laser-induced melt-pool, which can be, for example, on the order of 1 mm, can be influenced by many variables, such as the material, laser power, and process speed. The monitoring of the melt pool can be important to predicting the quality of the product that is formed during the process.

Understanding metals and alloys' melting and solidification is important for enhancing manufacturing processes such as welding and metal 3D printing. The physical properties of the processed workpieces may be highly dependent on the manufacturing methodology, particularly cooling rate related microstructure formation induced various dynamic elasticities and plasticities. The parts experience a re-melting and natural solidification process and result in enlarged grain size, which can reduce the mechanical performance and corrosion resistance. This phenomenon is often observed in laser welding and laser melting additive manufacturing. The melting and solidification occur in localized small melting pools within the bulk scale specimens. It can be spatially inhomogeneous for structures with complex shapes, which can introduce more challenges to numerically predict or experimentally characterize the properties of the manufactured materials. Furthermore, the sample fabrication status depends on the processing parameters such as laser power, scan speed, and laser beam scanning paths. An accurate melting pool monitoring method corroborated with a close-loop feedback-controlling system would be useful to prevent unexpected defects or flaws before initialization in the future.

The observation of the melting pool behavior in metal and alloy (metal/alloy) material systems can be demonstrated by various approaches, including spectral, optical, thermal, and radiational techniques. Laser-induced breakdown spectroscopy (LIBS) collects optical or even plasmonic emission of a sample induced by a high-power laser. With just an additional spectrometer needed in setup, this technique is broadly used in metal/alloy additive manufacturing (AM) as a melting pool monitoring method to collect chemical composition information from the pool. However, the spectrums may be noisy and complicated when the technique can be monitored the welding or printing processing of high entropy alloys or superalloys with numerous compositions. Optical or thermal camera imaging can be another method for the melt pool monitoring approach by visualizing melt pools' shape and temperature distribution from the top view. However, those techniques can lack in depth information which may also an important part of melting pool behaviors. Another recent work demonstrated X-ray imaging of melting pool cross-section in the in-situ setup on a thin printing sample, which may show high imaging clarity on the experimental obtained melting pool. However, the resolution or the imaging capability might be impacted when the sample's volume increased. All the listed methods can provide unique information about the melting pool behaviors during laser aided manufacturing. Ultrasound technique may be useful as another adding-on component to provide real-time information about the melting pool location, depth, and elasticity contrast to a solid region with pre-characterized acoustic properties of the target materials.

Disclosed herein are a system and method for in-situ monitoring of the melt pool behavior and optionally ex-situ inspection of the heat-affected softening in metal during the laser aided additive manufacturing process using an ultrasonic sensor. In laser welding and laser melting additive manufacturing processes, understanding the behavior of the melt pool can be challenging. Conventional processes involve mainly optical, thermal, and radiational imaging (X-ray) methods to provide valuable information about the object (also referred to herein as a “workpiece”) that is being at least one of manufactured and processed. Such techniques and sensors are limited due to the lack of penetration depth within the metal. Also the metal or plastic changes phase from solid to liquid during the melting process and subsequently recrystallizes from liquid to solid during the cooling process. This variable phase change in the materials is helpful to monitor during the processing of material during the 3D printing process.

An ultrasonic time of flight measurement sensing tool is described herein to study the behavior of laser-induced melting pools, including phase transition, pool initialization and growth, and solidification in real-time. Additionally, it has been discovered that a dynamic bulk modulus elastography (DBME) scan can be utilized to visualize the laser-heating induced mechanical property reduction as an ex-situ inspection process. The laser softening area can be imaged using an ultrasonic sensing technique, due to a drop in the strength or dynamic bulk modulus of the metal. The unique technique described herein can be suitable and helpful as a diagnostic tool to monitor the laser welding, laser melting-based additive manufacturing, and other melt solidification loop processes.

Herein disclosed is a monitoring technique for a laser-induced melting process. The monitoring technique comprises: monitoring a melt pool produced by a laser during the laser-induced melting process. The monitoring comprises measuring ultrasonic time of flight of the laser-induced melt pool via one or more ultrasonic transducers. The laser-induced melt pool (and thus a workpiece being processed via the laser-induced melting process from which the melt pool is formed) comprises one or more metals, alloys, or a combination thereof.

The one or more metals, alloys, or combination thereof can be selected from gallium, aluminum, magnesium, lithium, stainless steel, titanium, alloys of gallium, aluminum, magnesium, lithium, stainless steel, and/or titanium, and combinations thereof. The stainless steel may include any suitable amount of iron and carbon, and other additives such as at least one of chromium, nickel, manganese, silicon, nitrogen, copper, molybdenum, titanium, aluminum, niobium, sulfur, phosphorus, and selenium. In some exemplary embodiments, the stainless steel can include iron, about 0.02 to 1.5 weight percent (wt. %) carbon, about 10 to about 30 wt. % chromium, and optionally nickel. The purity of one or more metals, such as gallium, or one or more alloys, can be at least about 90 wt. %, about 95 wt. %, about 99 wt. %, about 99.5 wt. %, and about 99.9 wt. %. In embodiments, the laser-induced melting process comprises a laser welding process, a laser metal AM process, or another melt and solidify (melt/solidify) loop process. The laser-induced melting process can comprise a 3D metal printing or additive manufacturing process.

In aspects, the laser-induced melting process can be a femtosecond (fs) laser aided selective area melting process for a metal such as gallium. In such aspects, the laser can be a near-infrared femtosecond laser. Such a near-infrared femtosecond laser can have a sub 100 femtosecond pulse width. In some exemplary embodiments, the near-infrared laser can have, e.g., about 70, about 80, about 90, or about 100 fs pulse width. A laser source can be in a range of from about 700 to about 800 nanometer (nm), from about 750 to about 800 nm, from about 775 to about 800 nm, or greater than or equal to about 700, about 750, about 775, or about 800 nm.

Measuring ultrasonic time of flight can comprise high frequency acoustic scanning of the melt pool to monitor a height of the melt pool axially. The high frequency acoustic scanning can comprise producing, via the one or more ultrasonic transducers, a high-frequency acoustic wave. By way of example, such a high-frequency acoustic wave can have a frequency of greater than or equal to about 20, about 30, about 40, about 50, about 60, about 70, about 80, about 90, about 100, about 200, about 300, about 400, about 500, about 600, about 700, about 800, or about 900 kilohertz (kHz), or greater than or equal to about 1, about 2, about 3, about 4, about 5, about 6, about 7, about 8, about 9, about 10, about 11, about 12, about 13, about 14, about 15, about 16, about 17, about 18, about 19, or about 20 megahertz (MHz), or in a range of from about 20 kHz to about 20 MHz, from about 1 MHz to about 20 MHz, or from about 10 MHz to about 20 MHz. In some exemplary embodiments, the high-frequency acoustic wave can have a frequency of greater than or equal to about 20 kHz.

A high-frequency acoustic wave beyond 20 kHz has been used as a length scaler, flaw detector, and elasticity mapper. Measuring object length (d) by an acoustic wave is usually performed by the time of flight methods with known speed of sound values of the target media as d=0.5 c t, where c and t are speed of sound value and the time for pulse traveling of round-trip. Ultrasound discontinuity detection is the most common application of high-frequency acoustic waves in manufacturing and biomedical applications. The technique is based on the acoustic impedance mismatch-induced reflection. Based on the temporal position and amplitude, the discontinuity can be located spatially. In the welding field, ultrasound detection on the products is developed to evaluate the quality of the welded joints by measured the discontinuity. The technique can be realized by phased array transducers for an instant defect-map with the spatial information in two-dimensions. For a sample with a known size and geometry, its dynamic bulk modulus (K) can be determined by measuring the acoustic impedance (Z) and speed of sound (c) as a distribution map:

K=Zc.

During the monitoring of the melting pool, all the listed methods may provide information about the behavior of the melting pool during melting and solidification processes. The impedance mismatch between the solid and liquid phases regions results in reflection and imply about the relative position of interfaces within the entire sample along the wave propagation direction. The melting pool height can be estimated for a sample with a pre-characterized speed of sound values of the metal's solid and liquid phases. The amplitude of an internal echo can also provide information about the relative dynamic elasticity of the metallic structure that is being manufactured.

Measuring the ultrasonic time of flight of the laser-induced melt pool can further comprise measuring the temperature dependent speed of sound in the one or more metals, alloys, or a combination thereof, and calculating the height as object length (d) via the equation d=0.5 c t, wherein c and t are the speed of sound value of the target media (the workpiece) and the time for round trip pulse traveling, respectively.

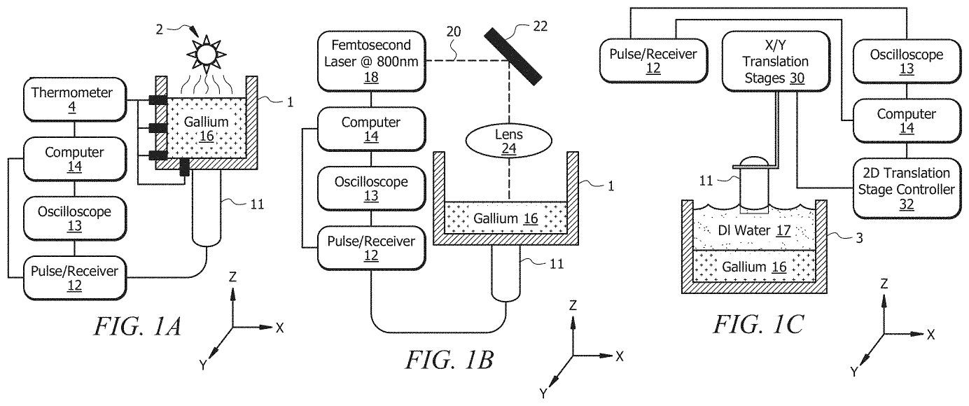

Also disclosed herein is a laser-induced melting system. As depicted in FIG. 1A, for measurement of the temperature dependent speed of sound using a radiation source such as an infrared lamp 2 can include: a workpiece 16 (e.g., sample 16, gallium sample 16, or gallium 16) positioned in a workpiece holder 1. The infrared lamp 2 is operable to heat the sample 16. A computer 14 can be operable to control processing of the workpiece 16 via infrared heating. The sensing system can include one or more ultrasonic transducers 11, a pulse/receiver 12, and an oscilloscope 13 in communication with the (or another) computer 14. An acoustic pulse can be excited by the ultrasound transducers 11 from the bottom of the workpiece holder 1. The acoustic property and thickness of the workpiece holder 1 are pre-examined by the same ultrasonic transducer 11. The electronic signal from the computer-controlled pulse/receiver 12 is reflected and collected and acquired by the oscilloscope 13. The gallium sample 16 can be slowly heated by the at least one infrared lamp 2. The temperature determined by averaging values from four thermocouples embedded in the wall of the workpiece holder 1 and communicating with a thermometer 4. The systematic uncertainty of the time of flight measurement is dependent on the temporal interval of the acquiring equipment.

As depicted in FIG. 1B, a laser-induced melting system can comprise: the workpiece 16 (e.g., sample 16) positioned in a workpiece holder 1; a laser 18 providing a beam 20 to a mirror 22 directed through a lens 24 and operable to produce a melt pool in the workpiece 16; the computer 14 operable to control processing of the workpiece 16 via laser-induced melting with the laser 18; and the sensing system described herein. A thinner sample 16 and a larger laser 18 may be used to quickly create a melt pool. The lens 24 can focus the beam 20 on a smaller spot on the sample 16. To slow melting, the lens 24 can be adjusted to decrease the focus. As noted previously, the sensing system can include the one or more ultrasonic transducers 11, pulse/receiver 12, and oscilloscope 13 in communication with the (or another) computer 14. As depicted in FIG. 1B, the one or more ultrasound transducers 11 can be positioned adjacent the workpiece holder 1. In embodiments, the one or more ultrasound transducers 11 are positioned under, such as ex situ, (e.g., attached to a bottom of) the workpiece holder 1. As noted hereinabove, the one or more ultrasound transducers 11 can comprise an array of ultrasound transducers 11, and the system can further comprise an automatic translation system that can be applied to the array such that the array of ultrasound transducers 11 follows a laser scan motion of the laser 18. The system can further comprise a heat shield or heat isolator layers to protect the one or more ultrasound transducers 11 from a heat of the laser 18.

Referring to FIG. 1C, the dynamic bulk modulus and effective density elastography (EDE) are performed. A workpiece 16 (e.g., sample 16) is positioned in a tank 3 and covered with deionized (DI) water 17. The computer 14 is operable to control processing of the workpiece 16 via an immersed ultrasound transducer 11 in the DI water 17. The ultrasonic transducer 11 excites a broadband pulse. The sensing system can include the one or more ultrasonic transducers 11, the pulse/receiver 12, and the oscilloscope 13 in communication with the (or another) computer 14. A program is used to control the entire raster scanning process, including the automated movement of transducer 11 and data acquisition. The ultrasonic transducer 11 is attached to a three-axis translation stages 30 controlled by a motion controller 32, such as a two-dimensional (2D) translation stage controller as depicted, in turn communicating with the computer 14. The pulse/receiver 12 internally operates the pulse source and time trigger, and the oscilloscope 13 is used to collect the data.

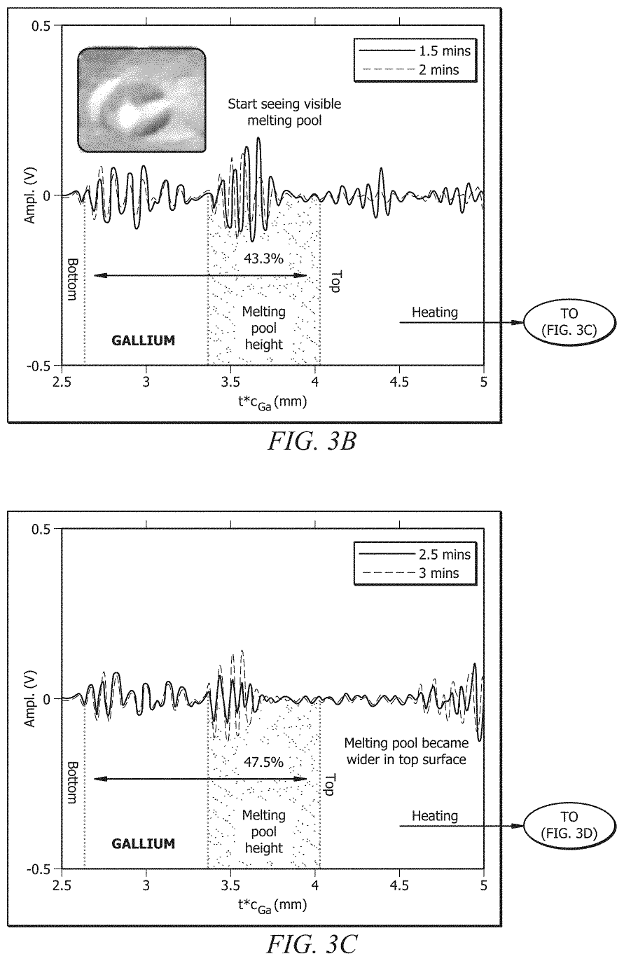

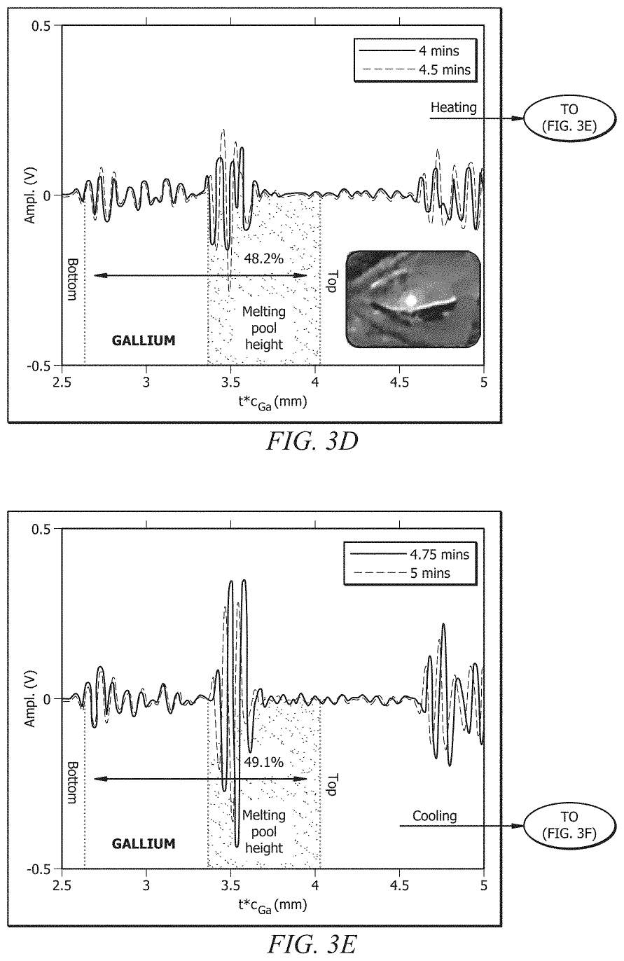

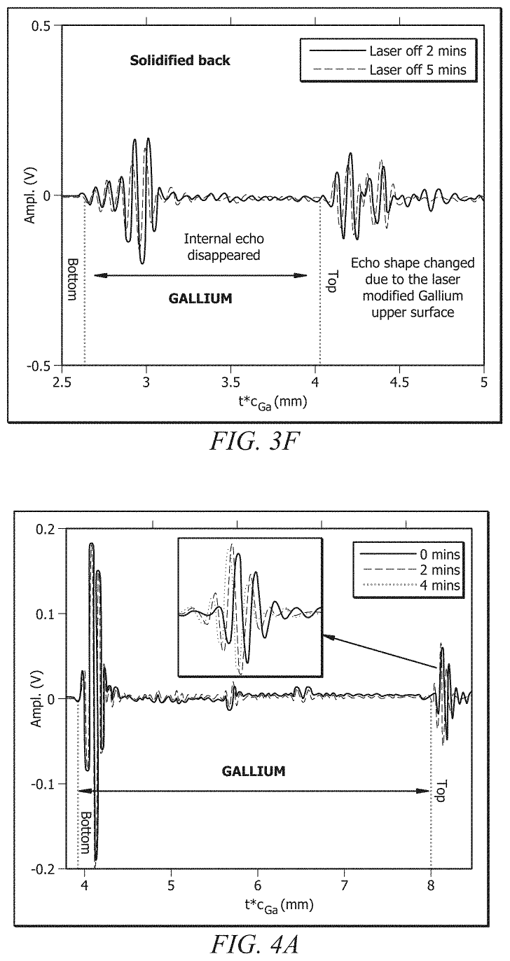

Referring to FIGS. 3A-F, the feasibility of the ultrasonic time-of-flight melting pool monitoring may be demonstrated by the above numerical simulation. Experimentally, the melt pool of the selective area melting process of solid gallium irradiated by a red femtosecond laser and the subsequent solidification process can be monitored using a non-invasive ultrasonic scanning process. Referring to FIGS. 3A-F, the temporal profile of the ultrasonic pulse traveling through the gallium metal sample is depicted. The thickness of the gallium sample used in this experiment may be about 1.4 mm. The state of the gallium target due to selective laser irradiation can be estimated from the distance traveled by the ultrasound pulse within the metal. Generally, the distance estimation depends on the speed of sound in the medium and is modified by the gallium phase under laser irradiation. The horizontal axis can be translated to an axial position (in mm) from the experimentally recorded time-of-flight of the ultrasonic pulse. The dashed line trace may be time delayed compared to the solid line trace in each of the of FIGS. 3A-F. Referring to FIG. 3A, the initial waveform of acoustic echoes from the gallium sample at 0 s and 60 s is depicted. The solid line trace at 0 s can infer the initial condition of the pulse propagating through the sample without the laser irradiation. Generally, the dashed line trace at two minutes in FIG. 3B indicates the pulse propagation 60 seconds after the laser is turned on and induces metal heating. The first echo can be observed from the interface between the container box and gallium metal at the 3 mm (on the x-axis) location. The second echo at 4.5 mm (x-axis) may be observed from the top surface, which can be the interface between gallium and ambient air. The ultrasound reflection may indicate an agreed value from 2.6 mm to 4 mm. From the zoom-in depicted in FIG. 3A, which is at 0 to 60 second(s) heating time, an extra small echo appeared on the dashed line showing the presence of an internal discontinuity, which indicated the initialization of a melting pool inside the gallium sample. At this moment, no visible melting pool on the upper surface is observed by the camera, which can mean the melting pool diameter on the upper surface is smaller than the laser spot size (<1 mm). Axially, from the location of the small echo on the x-axis, the estimated initial melting pool height is about 29.2% depth of the gallium, which is about 0.44 mm from the upper surface. In the presence of continuous irradiation of the gallium sample for 1.5 minutes, a visible melting pool on the upper surface can appear, as illustrated in the optical image shown in FIG. 3B. The zoomed-in echo signal is shown within the inset of FIG. 3A increases at this stage, as shown in FIG. 3B. The height of the melting pool sharply can increase to 43.3% of the entire gallium sample thickness. Additionally, the amplitude of the first echo can be reduced due to the phase transformation of the rest of the sample thickness below the melt pool. As the laser is continuously irradiated, inducing heating within the sample, the internal echo gradually moves to the left of the time domain. It approaches the lower boundary of the gallium sample, as shown in FIGS. 3B-E. The amplitude of the reflected envelopes increased proportionally to the laser irradiation or heating time. As shown in FIG. 3E, thermal equilibrium is observed when the final estimated melting pool height approaches 49.1%.

The laser can then be turned off to monitor the cooling and the solidification process continuously. After two minutes of cooling, the gallium solidified back, and the internal echo may no longer be observed. The discontinuity that appears due to the bottom gallium layer's phase transition and the melting pool may not be observed any longer as gallium can be gradually transformed back to the mixed state. The waveform also changed back to the original shape in FIG. 3F. The shape of the second echo in FIG. 3F is slightly different comparing to FIG. 3A as the gallium surface at the metal-air interface is modified by the laser-induced melting process.

In aspects, monitoring can comprise monitoring the phase transition, melt pool initialization, melt pool growth, melt pool solidification, or a combination thereof in substantially real time. The monitoring technique can further include visualizing a laser-heating induced reduction of a mechanical property of a workpiece being monitored via an ex-situ inspection process. In such aspects, the mechanical property can comprise a dynamic bulk modulus, in which aspects of the ex-situ inspection process can comprise preparing a dynamic bulk modulus elastography (DBME) scan. Thus, a melt pool monitoring system and method is disclosed herein. What is more, a laser-induced melting system and method comprising the melt pool monitoring system and method and/or comprising the system and method for dynamic bulk modulus elastography (DBME) mapping are disclosed herein.

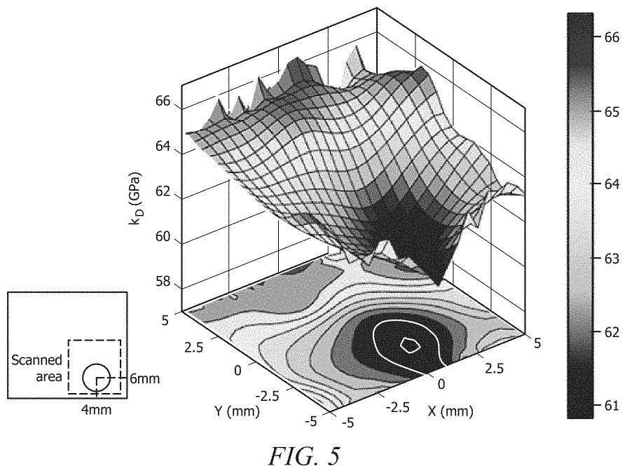

Referring to FIG. 5, the capability of the elastography technique can be been demonstrated by considering an anisotropic heat-transfer field along the horizontal plane. A location near the corner may be selected as illustrated within the inset of FIG. 5 instead of the selective area melting of the gallium at the center of the sample. The heat diffusion to the bottom and right side of the sample can be reduced by selecting this location, which can lead to more significant heat-affected softening around the melting pool close to those two edges. The dynamic bulk modulus elastography can examine the elasticity contrast. The laser softened area may have a drop in the dynamic bulk modulus resembling a melt pool's shape. The estimated modulus of the unaffected solid gallium is around 65 GPa. The laser melted region may have a lower modulus, which can be in the range of between about 63 GPa and about 61 GPa. The softened area center may be located at (−0.5, −3) on the XY plane in the elastography. The dynamic elasticity drop is more critical along the Y direction at −0.5 mm on X-axis rather than along the X direction from the center. This experiment demonstrated an inspection regimen for the regions of over-heating or lack-of-heating in the metal/alloy laser-aided manufacturing products.

Also disclosed herein is a laser-induced melting process to process a workpiece to provide a processed workpiece, the laser-induced melting process comprising: applying a laser to the workpiece, wherein applying the laser to the workpiece produces a melt pool; and monitoring the melt pool in real time or substantially real time via the monitoring technique described herein.

In embodiments, the laser-induced melting process of this disclosure further comprises: controlling one or more operating parameters (e.g., continuing the process, ceasing the process, a cooling rate, a laser power, a laser scan speed, a laser beam scanning path, or the like, etc.) of the laser-induced melting process based on the monitoring. In aspects, controlling the one or more operating parameters can be effected substantially in real time via a closed-loop feedback control system. Controlling the one or more operating parameters of the laser-induced melting process based on the monitoring can further comprise predicting one or more properties of the processed workpiece based on the monitoring. The one or more properties being predicted can include a mechanical strength, a density, a defect, or a combination thereof in the processed workpiece.

The laser-induced melting process of this disclosure can further comprise utilizing the predicting in a feedback loop to control the one or more operating parameters (e.g., continuation or cessation) of the laser-induced melting process.

In aspects, the laser-induced melting process further comprises: using an ultrasonic sensing technique to monitor, ex situ, a laser-induced reduction in at least one mechanical property of the product. Such an ex situ ultrasonic sensing technique is discussed above. In some such aspects, the at least one mechanical property can include a strength or dynamic bulk modulus of the product. Using the ultrasonic sensing technique can further comprise preparing a dynamic bulk modulus elastography (DBME) scan, as discussed above. Thus, a system and method for dynamic bulk modulus elastography mapping (DBME) is disclosed herein.

In aspects, the one or more ultrasonic transducers comprise an array of ultrasonic transducers. In such aspects, an automatic translation system can be utilized to cause the array of ultrasound transducers to follow a scan motion or path of the laser.

The laser-induced melting process can include utilizing a collimator or super-resolution meta-material lens to increase a spatial and/or depth resolution of the monitoring technique. In embodiments, the monitoring technique has a penetration depth of several (e.g., at least 1, 2, 3, 4, or 5) decimeters or more. A heat shield or heat isolator layer(s) can be utilized to protect the one or more transducers from a heat of the laser.

Also disclosed herein is a sensing system for carrying out the monitoring technique as disclosed herein (i.e., for monitoring the melt pool produced by the laser during the laser-induced melting process, the monitoring comprising measuring ultrasonic time of flight of the laser-induced melt pool via one or more ultrasonic transducers, wherein the laser-induced melt pool comprises one or more metals, alloys, or a combination thereof). The sensing system can comprise one or a plurality of the ultrasound transducers, pulse/receiver, oscilloscope, and/or computer.

The workpiece, and thus the melt pool formed therefrom, can comprise one or more metals, alloys, or combination thereof, for example, selected from gallium, aluminum, magnesium, lithium, stainless steel, titanium, alloys of gallium, aluminum, magnesium, lithium, stainless steel, and/or titanium, and combinations thereof. The laser-induced melting process effected by the laser-induced melting system can comprise a laser welding system, a laser metal additive manufacturing (AM) process, or another melt solidify loop process. In embodiments, the laser-induced melting process effected by the laser-induced melting system comprises a 3D metal printing or additive manufacturing process. In aspects, the laser-induced melting process effected by the laser-induced melting system is a femtosecond laser aided selective area melting process, in which aspects the laser is a near-infrared femtosecond laser, as discussed above.

A simplified model of laser melting solid gallium samples can demonstrate the in-situ monitoring of melting pool and ex-situ inspection of laser modified areas. As the initial step of study, gallium may be suitable to be a simplified model testing the feasibility of ultrasound melting pool monitoring due to its relatively slow phase transition and low melting point. Unlike most of other metals, gallium can have decreasing speed of sound value but increasing density value when it transits from solid phase to liquid phase. The resulting acoustic impedance of gallium generally does not have a clear drop during the phase change, as compared to metals or alloys, and may provide more energy reflected back at the solid and liquid (solid/liquid) interface. Due to its special temperature dependent impedance, gallium is generally considered as a challenge to study during the monitoring of a melting pool.

Before the actual monitoring, the temperature-dependent speed of sound in gallium can be characterized for further estimation of the position and size of the melting pool. For properly applying the time-of-flight method for estimating location or distance, the speed of sound information of the target material can be required. Using the characterized material properties, the feasibility of localizing the melting pool by ultrasound can then be proved by numerical simulation. In experiments, a 1.87 watts 800 nm femtosecond laser may be used instead of a high power continuous laser to slow down the melting process and speed up the solidification of the gallium samples. Two runs of ultrasonic melting pool monitoring examinations can be conducted with faster and slower speeds of melting to demonstrate different melting pool initiation and growth behaviors. The speed steps of the melting process may be manipulated by varying the size of laser focal point and the thickness of solid gallium sample. The experimental results can demonstrate the exceptional feasibility of ultrasound melting pool monitoring. In addition, for demonstrating the ex-situ ultrasound inspection capability of laser modified area, the dynamic bulk modulus elastography scan can be conducted on one of the gallium samples after solidifying back from the laser induced melting. The examined dynamic bulk modulus distribution map may depict a pool-like soften region on the gallium sample due to the laser-induced melting process. In-situ monitoring of the laser-induced melting of solid gallium samples and ex-situ inspection of the modified areas due to the femtosecond laser-metal interaction is demonstrated. The dynamic bulk modulus elastography scan of the irradiated laser area of the sample after solidification following the laser-induced melting process can be used for the ex-situ diagnostics. The examined dynamic bulk modulus distribution map demonstrates a pool-like soften region on the gallium sample due to the laser-induced melting process.

Ultrasound monitoring of laser-induced melting on solid gallium can demonstrate the feasibility of using ultrasound to observe melting behavior in selective areas. Due to abnormal density increasing from solid to liquid phase of gallium, the acoustic impedance mismatch between solid and liquid phases gallium is not significant compared to most of other common metals or alloys, which can introduce a greater challenge as compared to a gallium system to distinguish the interface between solid and liquid phases regions. In the rapid phase transition process, the recorded behavior can show the initial melting process, leading to a melt pool's formation and continuous growth. In the thicker sample, the behavior of the gallium surface can be examined due to the slower transition processing. The growth of melting pool depth may be illustrated as a gradual process. After removing the heating source, both of the samples may solidify back with a slight modification of surface conditions, which may also be visualized by the ultrasound monitoring. The ex-situ dynamic elasticity distribution map can illustrate the heat modified dynamic elasticity in and around the melting pool. With the commonly used operating frequency of ultrasound non-destructive testing, the attenuation of waves in metals and alloys may be insignificant, which can allow the acoustic pulses to penetrate decimeters easily. For the higher axial or lateral resolution of melting pool monitoring and elasticity mapping, an acoustic collimator or super-resolution meta-material lens can further be applied to increase the spatial and depth resolution of the monitoring system.

In general, based on this work, the ex-situ part of the proposed methods can be directly applied to the current laser aided manufacturing products. The elasticity distribution can be determined with additional information about the overheated or lack-of-heating phenomenon that occurred during the manufacturing. However, as the initial step of the study direction, the in-situ monitoring method may still be requested for long-term development to be practical for industrial cases such as laser welding and laser melting additive manufacturing. Currently, there may still be many circumstances, including thermal management, laser translation speed, and complex geometry, to directly apply the proposed in-situ method to metal AM and laser welding processing. The potential study directions in the future can be characterizing the performance of the efficiency thermal isolation, high-temperature stable ultrasound transducer, smart motion transducer arrays, and ultrasound resonance mode analysis in AM processes to overcome the limitations.

Thus, a new in-situ monitoring method for determining the behavior of the laser-induced melting pool is depicted, and an ex-situ method mapped out the laser-heated softened region in terms of dynamic elasticity, in, e.g., the low melting point gallium system. On the in-situ monitoring side, the feasibility of ultrasonic detection of the initialization, growth, and solidification behaviors of a melting pool is demonstrated. The parameters of the melting pool can be also estimated including the location, depth, and surface deformation. The method performance can be tested by both numerical and experimental approaches. On the ex-situ inspection side, a dynamic bulk modulus elastography can determine the dynamic elasticity drop in the laser soften region. The method may be applied in future laser-aided manufacturing applications to inspect overheated or lack-of-heating regions in the products. Additional advantages may be apparent to one of skill in the art viewing this disclosure.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

Gallium is an exemplary metal for testing the feasibility of ultrasound melting pool monitoring due to its relatively slow phase transition and low melting point. The temperature-dependent acoustic properties of gallium metal are experimentally investigated before studying the laser-induced phase transition of the melting pool. Relatively low power of the radiation from an 800 nm laser source, with 100 fs pulse width and 80 MHz pulse repetitions, is applied to slow down the gallium's melting process and speed up the irradiated metal's solidification. The ultrasonic melt pool behavior is monitored for varying rates of the melting process and metal fabrication process. The melting process's speed steps are manipulated by changing the size of the laser focal point and the thickness of the solid gallium sample. The size of the laser focal point is referred to the beam diameter at the focus. The experiment results demonstrate the exceptional feasibility of ultrasound melting pool monitoring. The initial characteristics of the speed of sound in gallium are determined using a pre-prepared bulk 25.4 mm wide cubic solid gallium that is slowly heated by infrared radiation. Simultaneously, the acoustic pulse is continuously excited for recording the time-of-flight information for calculating the speed of sound. The schematic of the experiment setup is shown in FIG. 1A.

### Example 2

### Gallium Melting Pool Detection by Numerical Simulation

The feasibility of using ultrasound pulse detecting the liquid phase melting pool formation and growth is firstly estimated by numerical simulation. The software may be a finite element based software sold under the trade designation COMSOL Multiphysics® 5.4 by COMSOL, Inc. of Burlington, Mass. (hereinafter “Comsol”). In its time-domain pressure acoustic module, a 6 mm width ultrasound transducer can send a 20 MHz pulse envelope written as x(t)=sin(2πf₀t)e^{-f}^{₀}^{(t-δT}^{₀}⁾^{²}, where f₀=20 MHz, T₀=1/f₀ and δ=3 are the fundamental frequency, period, and delay of the pulse signal and t is time in unit of second. The solid gallium sample is placed above the transducer with width and height equal to 9 mm and 3 mm. The boundary probe is located at the interface between the transducer and solid gallium sample, which collects the acoustic pressure after the pulse is sent. The melting pools are modeled as a semi-ellipse with height and width as “a” and “3a” on the upper surface of the solid gallium sample. The initialization and growth of the melting pool are demonstrated as the value sweeping of the factor “a” from 0 to 1 mm with a 0.25 mm interval. The outer boundary is set to sound hard boundary. The time-domain for time-of-flight data is recorded at 80 T₀ length and T₀/10 interval. The averaged mesh size is about 0.87 micron (μm). The largest mesh element has the size at 2.67 μm. The speed of sound and density values of solid and liquid phase gallium is experimentally determined as 3,255 meter per second (m/s) and 5,925 kilogram per meter-cubed (kg/m³) for solid-phase, 2,820 m/s and 6,100 kg/m³ for the liquid phase.

### Example 3

### Gallium Sample Preparation

The solid gallium samples are prepared from melting and solidification. The gallium metal is obtained from Sigma-Aldrich, a subsidiary of E. Merck KG of Darmstadt, Germany, about 99.9 wt. % gallium in a solid-state. For molding process of the samples, the 99.9 wt. % gallium is kept in the original container, slowly heated up by convectional heat with 40° C. ambient water baths. After the solid gallium in the container is completely melted, the liquid state gallium is filled into pre-prepared testing boxes with upper side opened. The samples are naturally cooled until solidification. The testing containers for the temperature-dependent speed of the sound experiment are in a 1 inch (25.4 mm) wide cubic shape. The ultrasound monitoring experiment containers are shaped in 1.5 inches (38.1 mm) wide square in horizontal cross-section with 1.4 mm (sample 1) and 4.1 mm (sample 2) height.

### Example 4

### Speed of Sound and Ultrasonic In-Situ Monitoring Laser-Induced Melting on Gallium

The experimental setup of the temperature-dependent speed of sound measurement is demonstrated in FIG. 1A. The acoustic pulse at 20 MHz fundamental frequency is excited every 10 millisecond (ms) by a 0.125 inch diameter (3.175 mm) unfocused emersion pencil style transducer sold under the trade designation V316-N-SU by Olympus of Tokyo, Japan (hereinafter “Olympus”) from the bottom of the sample container. The acoustic property and thickness of the bottom wall are pre-examined by the same transducer. The electronic signal from a computer-controlled pulse/receiver sold under the trade designation JSR Ultrasonic® DPR 300 from Imaginant, Inc., of Pittsford, N.Y. (hereinafter “JSR”). The reflected signal can be collected and acquired by an oscilloscope sold under the trade designation MDO 3024b by Tektronix a subsidiary of Fortive Corporation of Everett, Wash. (hereinafter “Tektronix”), in the time domain at a 2 GHz sampling rate. In the experiments, gallium samples are slowly heated up by two 600 watts infrared lamps. The temperature determined by averaging values from four ceramic thermocouples from Omega Engineering Inc., of Norwalk, Conn., is embedded on the container's wall as depicted in FIG. 1A. The systematic uncertainty of the time of flight measurement is dependent on the temporal interval of the acquiring equipment. The temporal interval of the data points is 0.5×10⁻⁸which is small enough to be negligible.

Referring to FIG. 1B, the general experimental setup involved in in-situ monitoring experiments can be similar to the temperature-dependent speed of sound measurement. For the in-situ measurements, a 20 MHz transducer can be attached under the plastic container filled with a solid gallium sample and a femtosecond laser (800 nm at 100 fs) may be used to heat the sample. A thinner gallium sample and large laser power may be used to induce a melting pool with faster speed. The power of the laser pulse can be 1.87 watts. The fast transition experiment may use a smaller focused laser spot of about 0.5 mm. The slow melting experiment may have an enlarged focused beam-width of about 1.2 mm. The estimations of the spot size may be from the pixel-counting based on the camera images.

### Example 5

### Dynamic Bulk Modulus and Effective Density Elastography (EBME)

Referring to FIG. 1C, the experiment of dynamic bulk modulus and effective density elastography (EBME) may be performed in a 500 mm cubic acrylic water tank filled with DI water. The gallium sample and ultrasound transducer may be immersed underwater, as depicted in FIG. 1C. The scanned area of the sample can be 10 mm×10 mm with a 0.5 mm step interval. A square matrix may be used to acquire and record the 441 position points of temporal data for each location. A script sold under the trade designation MATLAB® by MathWorks of Natick, Mass. (hereinafter “Matlab”) may be used to control the entire raster scanning process, including the automated movement of transducer and data acquisition. A 0.125 inch (3.175 mm) diameter 20 MHz unfocused emersion an Olympus pencil transducer may be used for exciting a broadband pulse of about 10-about 35 MHz (center frequency at 20 MHz) at a repetition rate of 100 Hz. The transducer may be attached to a three-axis translation stage (LC Series Linear Stages by Newmark Systems, Inc. of Rancho Santa Margarita, Calif. (hereinafter “LC”)) controlled by a motion controller. A JSR pulser/receiver internally operated the pulse source and time trigger, and a Tektronix oscilloscope may be used to collect the data. The data acquisition rate can be the 20 second for 512 signals on the same position. The 512 signals on the same position may be averaged into one recoded waveform and displayed and collected in the oscilloscope at each measured location.

### Example 6

### Measurement of Speed of Sound in Gallium

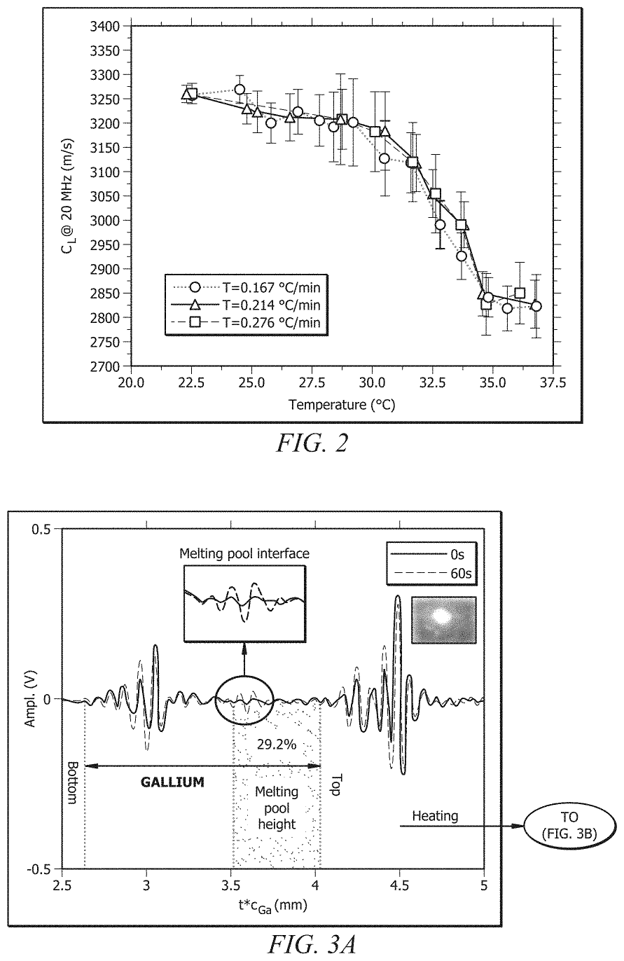

Before monitoring the melt pool of gallium metal due to laser irradiation, the temperature-dependent acoustic properties of solid and liquid gallium metal are experimentally measured. These measurements are performed at 20 MHz, which is the center frequency of the operating frequency band of the monitoring and inspection experiments. In FIG. 2, the sound velocity is characterized at three different heating rates. The data points are all averaged by three measurements, where the error bars indicate the standard deviation. These results depict a very consistent behavior of sound speed, which is independent of the heating rates. The sound speed is stable in the range from room temperature to 27.5° C. when the metal is in a solid-state and then from 34° C. to 37° C. when gallium is in a liquid state after phase transition. The gallium sample underwent a phase transformation from the solid-state to the liquid state as the temperature increases from 27.5° C. to 34° C. A dramatic reduction in the velocity is observed during this stage, which is about 15% at the rate of 71.5 m/(s° C.). In FIG. 1B, the measured acoustic attenuation values at the solid, liquid, and during phase transition are around 0.35±0.01 decibels per centimeter (dB/cm), 0.41±0.02 dB/cm, and 0.22±0.04 dB/cm, which are insignificant and negligible in the millimeter-scale samples monitoring experiments. The experimental speed of sound values of liquid state gallium agree with known values. In the solid state, the experimental speed of sound (attenuation) values are slightly lower (higher) than the known values possibly due to the higher operating frequency. The abnormal attenuation behavior of gallium is considered highly related to its abnormal density behavior between solid and liquid phases. These results are used for estimating the depth and width of the melt-pool during in-situ and ex-situ diagnostics.

### Example 7

### Numerical Results of Ultrasound Monitoring of Melting Pool Initialization and Growth

In FIG. 3, the numerical simulation results illustrate the time of flight measurements of a 3 mm thick solid gallium sample. For illustration of the measuring mechanism, acoustic pressure maps are obtained from time-domain numerical simulation with or without melting pool in FIGS. 3A and 3B. The source acoustic pulse is emitted from the bottom probe. The bottom probe is kept recording the reflection signals after the source pulse is excited. At a comparable time point, an additional reflection is observed as depicted in FIG. 3B due to the impedance mismatch occurred at the liquid solid interface. The additional echo is absent in the full solid gallium case in FIG. 3A. As FIG. 3C depicts, the solid gallium is modeled without a melting pool and initialized a melting pool which further grew from 0.25 mm deep to 1 mm with 0.25 mm interval. In FIG. 3D, the time of flight results of all studied 5 cases are demonstrated in the range of 0 microsecond (μs) to 3 μs. The two major echoes in each case indicate the lower and upper boundaries of the solid gallium layer. The first envelope around 0.5 μs is induced by the impedance mismatch between the transducer and the solid gallium that occurs at the interface between them. The first envelope has an identical amplitude and traveling time in all 5 cases due to the identical condition of the transducer and gallium interface. The second major envelope in all cases occurs around 2.5 μs, which is reflected from the upper surface of the gallium sample. The condition of the outer boundaries is reflecting all energy to represent the enormous impedance mismatch between gallium and ambient air in the practical experiment. The arriving time of the second major echoes has a slightly temporal delay, which is proportional to the height of the melting pool that has a lower speed of sound on liquid phase gallium. Besides the two major reflected envelopes, an additional echo is able to be found in the case with the melting pool temporally arrives before the major echo from the upper surface. The additional echo has a smaller amplitude comparing with the two major echoes due to lower impedance mismatch between solid and liquid phases gallium. In FIG. 3E, the presence of the additional reflections is due to the melting pool are illustrated clearly in the zoomed-in view as depicted in FIG. 3D. Comparing with the reference time of flight data collected without melting pool on solid gallium, a 0.12 μs width additional envelope appears before the upper surface reflection in the case of 0.25 mm height melting pool. With the rise of the melting pool thickness, the additional echo arrives earlier due to the forwarded grown solid and liquid interface. The height of the melting pools is able to be estimated by the time delay between the additional echo and the upper surface echo.

### Example 8

### In-Situ Melting Pool Monitoring of Rapid Phase Transition of Gallium

Referring to FIGS. 3A-F, the feasibility of the ultrasonic time-of-flight melting pool monitoring may be demonstrated by the above numerical simulation. Experimentally, the melt pool of the selective area melting process of solid gallium irradiated by a red femtosecond laser and the subsequent solidification process can be monitored using a non-invasive ultrasonic scanning process. Referring to FIG. 3, the temporal profile of the ultrasonic pulse traveling through the gallium metal sample is depicted. The thickness of the gallium sample used in this experiment may be about 1.4 mm. The state of the gallium target due to selective laser irradiation can be estimated from the distance traveled by the ultrasound pulse within the metal. Generally, the distance estimation depends on the speed of sound in the medium and is modified by the gallium phase under laser irradiation. The horizontal axis can be translated to an axial position (in mm) from the experimentally recorded time-of-flight of the ultrasonic pulse. The dashed line trace may be time delayed compared to the solid line trace in each of the FIGS. 3A-F. Referring to FIG. 3A, the initial waveform of acoustic echoes from the gallium sample at 0 s and 60 s is depicted. The solid line trace at 0 s can infer the initial condition of the pulse propagating through the sample without the laser irradiation. Generally, the dashed line trace at two minutes in FIG. 3B indicates the pulse propagation 60 seconds after the laser is turned on and induces metal heating. The first echo can be observed from the interface between the container box and gallium metal at the 3 mm (on the x-axis) location. The second echo at 4.5 mm (x-axis) may be observed from the top surface, which can be the interface between gallium and ambient air. The ultrasound reflection may indicate an agreed value from 2.6 mm to 4 mm. From the zoom-in depicted in FIG. 3A, which is at 60 second (s) heating time, an extra small echo appeared on the dashed line showing the presence of an internal discontinuity, which indicates the initialization of a melting pool inside the gallium sample. At this moment, no visible melting pool on the upper surface is observed by the camera, which can mean the melting pool diameter on the upper surface is smaller than the laser spot size (<1 mm). Axially, from the location of the small echo on the x-axis, the estimated initial melting pool height is about 29.2% depth of the gallium, which is about 0.44 mm from the upper surface. In the presence of continuous irradiation of the gallium sample for 1.5 minutes, a visible melting pool on the upper surface appeared, as illustrated in the optical image shown in FIG. 3B. The zoomed-in echo signal is shown within the inset of FIG. 3A increases at this stage, as shown in FIG. 3B. The height of the melting pool sharply increases to 43.3% of the entire gallium sample thickness. Additionally, the amplitude of the first echo can be reduced due to the phase transformation of the rest of the sample thickness below the melt pool. As the laser is continuously irradiated, inducing heating within the sample, the internal echo gradually moves to the left of the time domain. It approaches the lower boundary of the gallium sample, as shown in FIGS. 3B-E. The amplitude of the reflected envelopes increases proportionally to the laser irradiation or heating time. As shown in FIG. 3E, thermal equilibrium is observed when the final estimated melting pool height approaches 49.1%.

The laser is then turned off to monitor the cooling and the solidification process continuously. After two minutes of cooling, the gallium solidifies back, and the internal echo may no longer be observed. The discontinuity that appears due to the bottom gallium layer's phase transition and the melting pool is not observed any longer as gallium gradually transforms back to the mixed state. The waveform also changes back to the original shape in FIG. 3F. The shape of the second echo in FIG. 3F is slightly different compared to FIG. 3A as the gallium surface at the metal-air interface is modified by the laser-induced melting process.

### Example 9

### In-Situ Melting Pool Monitoring of Slow Phase Transition of Gallium

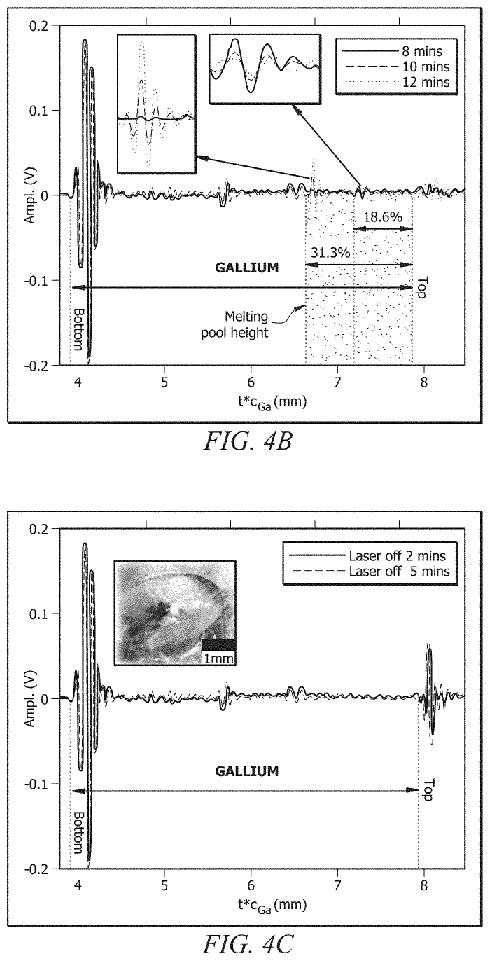

The experimental setup is modified using a thicker gallium sample heated by the laser with a lower power density to obtain a slow transition behavior. In FIG. 4A, the overall view of the recorded signals show lower and upper boundaries of the gallium sample with a zoom-out view. The lower boundary of the gallium sample has not changed position during heating and cooling processes. However, the upper boundary undergoes a deformation during heating and recovering during cooling. The behavior is verified by the photograph inserted in FIG. 4C depicting a deformed pool shape once the laser tuned off. The upper surface deformation is resulted by the density decreasing during the heating process. From the acoustic signals, we can estimate the maximum surface deformation occurred during the process is around 0.12 mm. FIG. 4B depicts that the upper surface provided a reflection envelope moves forward towards the bottom surface with increased laser heating time. This phenomenon indicates that the phase transformation occurs on the upper surface as a thin layer region. The density of the liquid state gallium is higher than the solid. As the laser-induced surface temperature is raised, the phase transformation within the thin layer zone undergoes a volume contraction due to the abnormally increased density. The forward-moving highlighted echo from time 0 to 4 minutes (mins) demonstrates the reduction of the local volume on the upper surface. Under constant laser irradiation, the initial bulk scale melting pool is observed at 18.6% height away from the upper surface after 8 mins heating, as shown by the solid line. The melt pool location is about 7.2 mm on the horizontal axis with a height of about 0.725 mm, as estimated from the internal echo, which is shown in the inset as a zoom-in figure of FIG. 4C. Through the two expanded traces within the inset in FIG. 4B, the melt pool location gets deeper at 10 minutes (dashed line). The amplitude of echo is in the intermediate position. After two more minutes, a clear melting pool signature echo is recorded at 31.3% of the original sample height showed by the black dotted line. Subsequently, the recorded waveform maintained an identical shape with further heating. FIG. 4C illustrates the waveform of the cooling process. Within 2 minutes of turning off the laser to cooling the sample, the observed waveform returns to the initial state, as observed in FIG. 4A at t=0 min. Thus, the gallium sample is completely solidified back to its original state.

### Example 10

### Ex-Situ Characterization of the Melt-Pool of Selective Area Laser-Irradiated Gallium Metal

The modification of the gallium's mechanical properties under the selective laser irradiated zone is estimated from the dynamic bulk elasticity measurement. The classical speed of sound theory is used to calculate dynamic bulk modulus: K=Zc and ρ=Z/c, where ρ is the density, c is the speed of sound, and Z is the impedance of the scanned material.

The acoustic impedance ratio between the sample and DI water is:

$$\frac{{Z}_{1}}{{Z}_{0}} = \frac{- 1 - α - \sqrt{4 α + 1}}{α - 2} \qquad ( 1 )$$

where the factor

$$α = \frac{{P}_{1}}{{P}_{e} - ( {Z}_{1} - {Z}_{0} ) \vert {P}_{0} \vert} ,$$

and is measured from the experiment. Pₑ is the amplitude of the emitted pulse from the transducer. P₀ and P₁ are the amplitudes of the first refection and second refection, respectively. Z₀ is the known acoustic impedance of ambient material DI water). Z₁ is the unknown impedance of the tested material.
Dynamic bulk modulus can be calculated using equation

$${K}_{d y n} = {C}_{L} {Z}_{0} \frac{- 1 - α - \sqrt{4 α + 1}}{α - 2} , \qquad ( 2 )$$

where C_{L} is the speed of the longitudinal wave from the temporal delay between the two reflections. FIG. 5 shows the results of ex-situ ultrasound inspection of the solid gallium sample, which has been laser melted in the previous section to estimate the dynamic bulk modulus distribution map. The total scanned area is 10 mm×10 mm with 0.5 mm step intervals on both axes. Although the gallium is fully solidified back to the solid state, the heat softening effect is still observed on the sample.

Referring to FIG. 5, the capability of the elastography technique has been demonstrated by considering an anisotropic heat-transfer field along the horizontal plane. A location near the corner is selected as illustrated within the inset of FIG. 5 instead of the selective area melting of the gallium at the center of the sample. The heat diffusion to the bottom and right side of the sample is reduced by selecting this location, which leads to more significant heat-affected softening around the melting pool close to those two edges. The dynamic bulk modulus elastography examines the elasticity contrast. The laser softened area has a drop in the dynamic bulk modulus resembling a melt pool's shape. The estimated modulus of the unaffected solid gallium is around 65 GPa. The laser melted region has a lower modulus, which is in the range of between about 63 GPa and about 61 GPa. The softened area center is located at (−0.5, −3) on the XY plane in the elastography. The dynamic elasticity drop is more critical along the Y direction at −0.5 mm on X-axis rather than along the X direction from the center. This experiment demonstrates inspecting the regions of over-heating or lack-of-heating in the metal/alloy laser-aided manufacturing products.

Having described various systems and methods herein, certain embodiments can include, but are not limited to:

In a first aspect, a monitoring technique for a melting process, the monitoring technique comprises: monitoring a melt pool produced by a heat source during the melting process, the monitoring comprising measuring an ultrasonic time of flight of the melt pool via one or more ultrasonic transducers, wherein the melt pool comprises one or more metals, alloys, or a combination thereof.

A second aspect can include the monitoring technique of the first aspect, wherein the one or more metals, alloys, or a combination thereof is gallium, aluminum, magnesium, lithium, stainless steel, titanium, one or more alloys of gallium, aluminum, magnesium, lithium, a stainless steel, titanium, or a combination thereof.

A third aspect can include the monitoring technique of the first or second aspect, wherein the melting process comprises a laser welding process, a laser metal additive manufacturing process, or another melt and solidify loop process.

A fourth aspect can include the monitoring technique of any one of the first to third aspects, wherein the melting process comprises a 3D metal printing or additive manufacturing process.

A fifth aspect can include the monitoring technique of any one of the first to fourth aspects, wherein the melting process is a femtosecond laser aided selective area melting process.

A sixth aspect can include the monitoring technique of any one of the first to fifth aspects, wherein the heat source comprises a laser, and wherein the laser is a near-infrared femtosecond laser having a sub 100 femtosecond (fs) (e.g., 70, 80, 90, or 100 fs) pulse width.

A seventh aspect can include the monitoring technique of any one of the first to sixth aspects, wherein measuring the ultrasonic time of flight comprises a high frequency acoustic scanning of the melt pool to monitor a height of the melt pool axially.

An eighth aspect can include the monitoring technique of the seventh aspect, wherein the high frequency acoustic scanning comprises producing, via the one or more ultrasonic transducers, a high-frequency acoustic wave, e.g., having a frequency greater than or equal to about 20, 30, 40, 50, 60, 70, 80, 90, 100, 200, 300, 400, 500, 600, 700, 800, or 900 kHz, or greater than or equal to about 1, 2, 3, 4, 5, 6, 7, 8, 9, 10, 11, 12, 13, 14, 15, 16, 17, 18, 19, or 20 MHz, or in a range of from about 20 kHz to about 20 MHz, from about 1 MHz to about 20 MHz, or from about 10 MHz to about 20 MHz.

A ninth aspect can include the monitoring technique of the seventh or eighth aspect, wherein measuring the ultrasonic time of flight of the laser-induced melt pool further comprises measuring a temperature dependent speed of sound in the one or more metals, alloys, or a combination thereof, and calculating the height as an object length via the equation d=0.5 c t, wherein c and t are the speed of sound value and the time for round trip pulse traveling, respectively.

A tenth aspect can include the monitoring technique of any one of the first to ninth aspects, wherein monitoring comprises monitoring a phase transition, melt pool initialization, melt pool growth, melt pool solidification, or a combination thereof in substantially real time.

An eleventh aspect can include the monitoring technique of any one of the first to tenth aspects further comprising visualizing a laser-heating induced reduction of a mechanical property of a workpiece being monitored via an ex-situ inspection process.

A twelfth aspect can include the monitoring technique of the eleventh aspect, wherein the mechanical property comprise a dynamic bulk modulus, and wherein the ex-situ inspection process comprises preparing a dynamic bulk modulus elastography scan.

A thirteenth aspect can include a melting process to process a workpiece to provide a processed workpiece, the melting process comprising: applying a heat source to the workpiece, wherein applying the heat source to the workpiece produces a melt pool; and monitoring the melt pool in real time or substantially real time via the monitoring technique of any one of the first to twelfth aspects.

A fourteenth aspect can include the melting process of thirteenth aspect further comprising: controlling one or more operating parameters (e.g., continuing the process, ceasing the process, a cooling rate, a laser power, a laser scan speed, a laser beam scanning path, or the like, etc.) of the melting process based on the monitoring.

A fifteenth aspect can include the melting process of the thirteenth or fourteenth aspect, wherein controlling the one or more operating parameters is effected substantially in real time via a closed-loop feedback control system.

A sixteenth aspect can include the melting process of the fourteenth or fifteenth aspect, wherein controlling the one or more operating parameters of the melting process based on the monitoring further comprises predicting one or more properties of the processed workpiece based on the monitoring.

A seventeenth aspect can include the melting process of the sixteenth aspect, wherein the one or more properties include a mechanical strength, a density, a defect, or a combination thereof in the processed workpiece.

An eighteenth aspect can include the melting process of the sixteenth or seventeenth aspect further comprising utilizing the predicting of one or more properties in a feedback loop to control the one or more operating parameters (e.g., continuation or cessation) of the melting process.

An nineteenth aspect can include the monitoring technique of any one of the thirteenth to eighteenth aspects further comprising: using an ultrasonic sensing technique to monitor, ex situ, a laser-induced reduction in at least one mechanical property of the product.

A twentieth aspect can include the method of the nineteenth aspect, wherein the at least one mechanical property includes a strength or dynamic bulk modulus of the product.

A twenty first aspect can include the melting process of the nineteenth or twentieth, wherein using the ultrasonic sensing technique further comprises preparing a dynamic bulk modulus elastography.

A twenty second aspect can include the melting process of any one of the thirteenth to twenty first aspects, wherein the one or more ultrasonic transducers comprise an array of ultrasonic transducers, and wherein an automatic translation system is utilized to cause the array of ultrasound transducers to follow a laser scan motion.

A twenty third aspect can include the melting process of any one of the thirteenth to twenty second aspects, further comprising utilizing a collimator or super-resolution meta-material lens to increase a spatial and/or depth resolution of the monitoring technique.

A twenty fourth aspect can include the melting process of any one of the thirteenth to twenty third aspects, wherein the monitoring technique has a penetration depth of several (e.g., at least about 1, 2, 3, 4, or 5) decimeters or more.

A twenty fifth aspect can include the melting process of any one of the thirteenth to twenty fourth aspects further comprising utilizing a heat shield or heat isolator layer(s) to protect the one or more transducers from a heat of the laser.

A twenty sixth aspect can include a sensing system for carrying out the monitoring technique of any one of the first to twenty fifth aspects (i.e., comprising monitoring the melt pool produced by the heat source during the melting process, the monitoring comprising measuring ultrasonic time of flight of the melt pool via one or more ultrasonic transducers, wherein the melt pool comprises one or more metals, alloys, or a combination thereof), wherein the sensing system comprises one or more of a plurality of ultrasound transducers, a pulse and receiver, an oscilloscope, and/or a computer.

A twenty seventh aspect can include a melting system comprising: a workpiece positioned in a workpiece holder; a heat source operable to produce a melt pool in the workpiece; a computer operable to control processing of the workpiece via melting with the heat source; and the sensing system of any one of the first to twenty sixth aspects.

A twenty eighth aspect can include the melting system of the twenty seventh aspect, wherein the one or more ultrasound transducers are positioned adjacent the workpiece holder.

A twenty ninth aspect can include the melting system of the twenty seventh or twenty eighth aspect, wherein the one or more ultrasound transducers are positioned under the workpiece holder.

A thirtieth aspect can include the melting system of any of twenty seventh to twenty ninth aspects, wherein the one or more ultrasound transducers comprise an array of ultrasound transducers, and wherein the system further comprises an automatic translation system applied to the array following a laser scan motion of a laser.

A thirty first aspect can include the melting system of any of twenty seventh to thirtieth aspects, further comprising a heat shield or heat isolator layers to protect the one or more ultrasound transducers from a heat of the laser.

A thirty second aspect can include the melting system of any of twenty seventh to thirty first aspects, wherein the melt pool comprises one or more metals, alloys, or combination thereof is gallium, aluminum, magnesium, lithium, stainless steel, titanium, one or more alloys of gallium, aluminum, magnesium, lithium, a stainless steel, titanium, or a combination thereof.

A thirty third aspect can include the melting system of any one of twenty seventh to thirty second aspects, wherein the melting process comprises a laser welding process, a laser metal additive manufacturing process, or another melt solidify loop process.

A thirty fourth aspect can include the melting system of any one of twenty seventh to thirty third aspects, wherein the melting process effected by the laser-induced melting system comprises a 3D metal printing or additive manufacturing process.

A thirty fifth aspect can include the melting system of any one of twenty seventh to thirty fourth aspects, wherein the melting process effected by the laser-induced melting system is a femtosecond laser aided selective area melting process.

A thirty sixth aspect can include the melting system of any one of twenty seventh to thirty fifth aspects, wherein the heat source is a near-infrared femtosecond laser (e.g., having a sub 100 femtosecond (fs) (e.g., 70, 80, 90, or 100 fs) pulse width).

A thirty seventh aspect can include the melting system of any one of twenty seventh to thirty sixth aspects, wherein the laser has a laser source in a range of from about 700 to about 800 nm, from about 750 to about 800 nm, from about 775 to about 800 nm, or greater than or equal to about 700, 750, 775, or 800 nm.

A thirty eighth aspect can include a melt pool monitoring system and method comprising any one of first to thirty seventh aspects.

A thirty ninth aspect can include a system and method for dynamic bulk modulus elastography mapping (DBME) comprising any one of first to thirty eighth aspects.

A fortieth aspect can include a laser-induced melting system and method comprising the melt pool monitoring system and method and/or comprising the system and method for dynamic bulk modulus elastography mapping (DBME) comprising any one of first to thirty nine aspects.

For purposes of the disclosure herein, the term “comprising” includes “consisting” or “consisting essentially of.” Further, for purposes of the disclosure herein, the term “including” includes “comprising,” “consisting,” or “consisting essentially of.”

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

What is claimed is:

1. A monitoring technique for a melting process, the monitoring technique comprising:
monitoring a melt pool produced by a heat source during the melting process, the monitoring comprising measuring an ultrasonic time of flight of the melt pool via one or more ultrasonic transducers, wherein the melt pool comprises one or more metals, alloys, or a combination thereof.

2. The monitoring technique of claim 1, wherein the one or more metals, alloys, or a combination thereof is gallium, aluminum, magnesium, lithium, stainless steel, titanium, one or more alloys of gallium, aluminum, magnesium, lithium, a stainless steel, titanium, or a combination thereof.

3. The monitoring technique of claim 1, wherein the melting process comprises a laser welding process, a laser metal additive manufacturing process, or a melt and solidify loop process.

4. The monitoring technique of claim 3, wherein the melting process comprises a three-dimensional 3D metal printing or additive manufacturing process.

5. The monitoring technique of claim 1, wherein the melting process is a femtosecond laser aided selective area melting process.

6. The monitoring technique of claim 1, wherein the heat source comprises a laser, and wherein the laser is a near-infrared femtosecond laser having a sub 100 femtosecond pulse width.

7. The monitoring technique of claim 1, wherein measuring the ultrasonic time of flight comprises a high frequency acoustic scanning of the melt pool to monitor a height of the melt pool axially.

8. The monitoring technique of claim 7, wherein the high frequency acoustic scanning comprises:
producing, via the one or more ultrasonic transducers, a high-frequency acoustic wave having a frequency greater than or equal to about 20 kilohertz (kHz).

9. The monitoring technique of claim 7, wherein measuring the ultrasonic time of flight of the laser-induced melt pool further comprises:
measuring a temperature dependent speed of sound in the one or more metals, alloys, or a combination thereof; and
calculating the height as an object length via the equation d=0.5 c t, wherein c and t are the speed of sound value and the time for round trip pulse traveling, respectively.

10. The monitoring technique of claim 1, wherein monitoring comprises:
monitoring a phase transition, melt pool initialization, melt pool growth, melt pool solidification, or a combination thereof in substantially real time.

11. The monitoring technique of claim 1 further comprising:
visualizing a laser-heating induced reduction of a mechanical property of a workpiece being monitored via an ex-situ inspection process.

12. The monitoring technique of claim 11, wherein the mechanical property comprise a dynamic bulk modulus, and wherein the ex-situ inspection process comprises preparing a dynamic bulk modulus elastography scan.

13. A melting process to process a workpiece to provide a processed workpiece, the melting process comprising:
applying heat from a heat source to the workpiece, wherein applying the heat source to the workpiece produces a melt pool; and
monitoring the melt pool in real time or substantially real time by measuring an ultrasonic time of flight of the melt pool using one or more ultrasonic transducers, wherein the melt pool comprises one or more metals, alloys, or a combination thereof.

14. The melting process of claim 13 further comprising:
controlling one or more operating parameters of the melting process based on the monitoring.

15. The melting process of claim 14, wherein controlling the one or more operating parameters is effected substantially in real time via a closed-loop feedback control system.

16. The melting process of claim 14, wherein controlling the one or more operating parameters of the melting process based on the monitoring further comprises predicting one or more properties of the processed workpiece based on the monitoring.

17. The melting process of claim 14, wherein the heat source is a near-infrared femtosecond laser.

18. A melting system comprising:
a workpiece positioned in a workpiece holder;
a heat source operable to produce a melt pool in the workpiece;
a computer configured to control processing of the workpiece via melting with the heat source; and
a sensing system comprising one or more of a plurality of ultrasound transducers, a pulse and receiver, an oscilloscope, or a combination thereof.

19. The melting system of claim 18, wherein the one or more ultrasound transducers are positioned adjacent the workpiece holder.

20. The melting system of claim 19, wherein the one or more ultrasound transducers are positioned under the workpiece holder.
